(19) United States
(12) Patent Application Publication
(10) Pub. No.: US 2010/0114653 A1
(43) Pub. Date: May 6, 2010

(54) Publishing System with Partner Matching

(75) Inventors: Ehud Chatow, Palo Alto, CA (US); Carl S. Chow, Fremont, CA (US); Andrew E. Fitzhugh, Menlo Park, CA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Packard Development Company, L.P., Houston, TX (US)

(21) Appl. No.: 12/263,100

(22) Filed: Oct. 31, 2008

(51) Int. Cl. G06F 17/30

(52) U.S. Cl. 705/10

(57) ABSTRACT

Systems and methods are described for publishing a document. In one example, a user interface, configured for profiling a document, a publisher of the document, a plurality of document consumers and a plurality of ad buyers, is displayed. The system may remove from the plurality of ad buyers those ad buyers whose goods or services are found to overlap areas of goods or services offered by the publisher. The removal may be performed in an automated manner, and as a backup, in a manual manner by a user operating the user interface. The document consumers are matched with the plurality of ad buyers to find ad buyers that are compatible with the document. Content provided by the publisher and ads provided by ad buyers found to be compatible with the content are then combined to form the document.

### BACKGROUND

Publishing a high quality periodical document, such as a magazine, is an expensive undertaking. The publisher must generate content suitable for the publication, as well as produce and maintain a listing of document consumers (recipients), find and contract with a commercial printer, and find advertisers to offset all or part of the costs.

Frequently, the publisher has content suitable for publication, and a list of document consumers to which to send a finished document. However, the publisher frequently lacks a suitable commercial printer to print the document, and also lacks advertisement buyers to help to offset the costs and/or make the venture profitable.

### SUMMARY

A publishing system with partner matching is disclosed herein. A publisher, having developed content for publication in a document, is matched with partners (advertisement buyers). The ad buyer(s) are suitably chosen to benefit both the ad buyer(s) and the publisher. Accordingly, the document produced will include both the publisher's content and the ad buyers' advertisements, and will be read by individuals and/or groups on the publisher's list of document consumers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates one embodiment of a publishing system, showing example aspects of the publishing system and relationships between the publisher, the printer, the ad buyers and the document consumers.

FIG. 2 illustrates one embodiment of a user interface, shown in a diagrammatic form, intended as an example for use in a discussion of concepts involved in the system, and not intended to illustrate any required elements of appearance or function.

FIG. 3 illustrates one embodiment of aspects of a publishing system, expressed as a diagram intended as an example of the relative interests of the publisher (content author), the ad buyers (advertisers) and the document consumers (document receivers and associates).

FIG. 4 illustrates one embodiment of a publishing system, expressed as a flow chart showing an example of a method of operation.

### DETAILED DESCRIPTION

### Overview

The following discussion is directed to systems and methods wherein a publishing system with partner matching is used to publish a document, such as a periodical magazine. Partner matching involves aspects of matching the publisher (i.e. a content generator, provider and/or author) with ad buyers (i.e. advertisers paying to place advertisements). This allows the publisher to leverage and/or benefit from the possession and maintenance of a list of document consumers (e.g. document receivers and associates) by selling advertising to the ad buyer that is very highly targeted in a manner not seen in mainstream publishing. In one example of the publishing system and associated method, a user interface is displayed to the publisher, and in some applications, the ad buyers. The user interface is configured for receiving and displaying data profiling one or more of: a publisher of the document; the document to be published; a plurality of document consumers; and a plurality of ad buyers. Different versions of the user interface may be presented to the publisher and ad buyers. The profiling may be performed using written descriptions, key word associations, a classification schedule or other system, as desired. For example, the publisher and the ad buyer(s) may enter key words and/or statements describing the content and area of advertised business, respectively. The publisher may also profile the document consumers by entering key words and/or statements describing the background, business and/or interests of the document consumers. The document consumers include document receivers (i.e. those to whom the document is ultimately delivered) along with any associates, friends and/or co-workers that may also view (consume) the document. To protect the business interests of the publisher, the system may remove—or allow removal of—ad buyers whose goods or services are found to overlap areas of goods or services offered by the publisher. The removal may be performed in an automated manner, such as, for example, when key words indicate the overlap. The user interface may provide an alternate and/or backup means for the publisher (or printer, in some applications) to manually remove ad buyers conflicting with the publisher. The document consumers are matched with the plurality of ad buyers to find ad buyers that are compatible with the document. In some applications, this matching is performed using an automated system, such as an auction. Alternatively, this matching may be done manually, but allowing the publisher to enter into the user interface information about an ad buyer (advertiser) known to the publisher. The matching may be based in part on the geographic location of the document consumers, wherein differently located document consumers receive documents with different advertisements by the same or different ad buyers (advertisers). The advertisements are also entered to the user interface; for example, PDF documents may be uploaded. The document is then printed, using content provided by the publisher, together with ads provided by ad buyers found to be compatible with the document. In some cases, the copies of the document are printed in different locations, for reasons of economy of scale and/or transport, particularly where the document consumers are widely dispersed geographically. The document is then distributed to the document consumers on the publisher's list of document consumers.

### EXAMPLE ENVIRONMENT

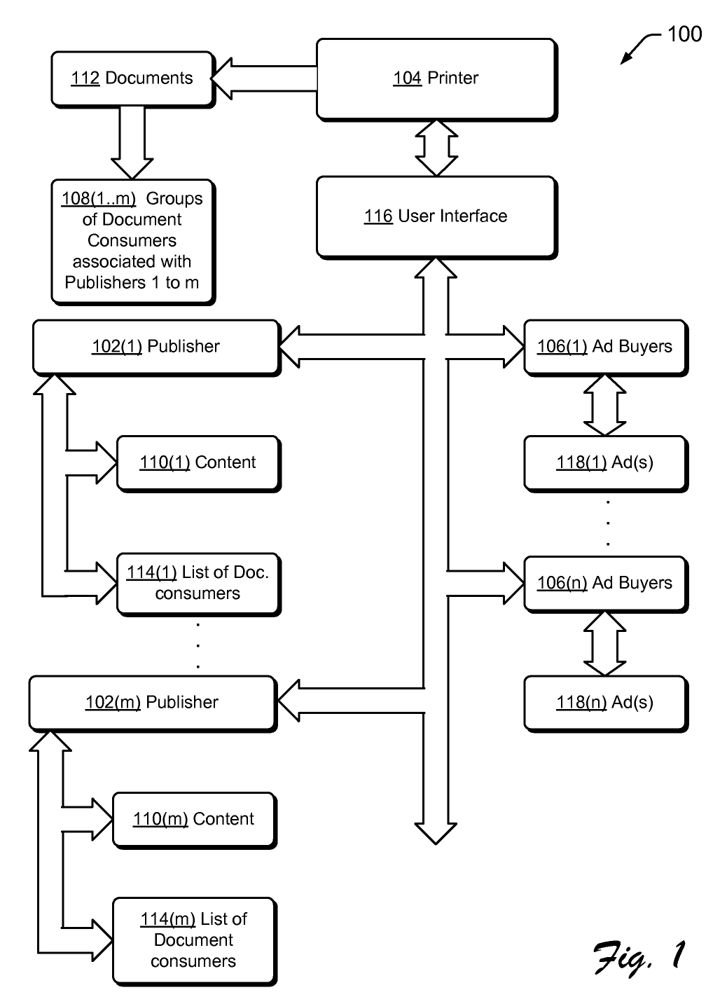

FIG. 1 illustrates an example of a publishing system 100, showing aspects of the publishing system and relationships between the publisher 102, the printer 104, the ad buyers 106 and the document consumers 108. The publisher 102 can be the artist, author or owner of the content 110 that is ultimately published in (typically a plurality of copies of) documents 112. The publisher may be a major or aspiring news source, a small club (e.g. a “Model T owners club,” an association of soccer moms, a children's swim team, etc.), a business (e.g. a real estate agent, an attorney, a dentist, etc.), a non-profit organization (e.g. a pet rescue, a hospital, etc.) or any other person, company, corporation, organization or association that has content to publish in the form of a document.

The content 110 is typically organized as a PDF (portable document format) document or file, but could be organized in any similar manner, as desired or required by operation of the system 100. The content may include text, photographs, graphics and any other content that can be organized into a PDF or similar file/document format.

One or more publishers 102(1) to 102(m) typically each possess and manage a list 114(1) to 114(m) of document consumers 108(1) to 108(m). The list 114 of document consumers 108 may be a list of employees of an organization, a list of customers or clients of a business or professional, a list of patients of a doctor, dentist, clinic, hospital, etc., or other list of individuals, groups, associations or similar. It is typically the case that all members of the list 114 of document consumers 108 have something in common with the publisher 102. For example, the list of document consumers may be the patients, clients, customers, etc. of the publisher 102, who is the doctor, CPA, or business, etc., associated with the document consumers.

The list 114 of document consumers 108 is frequently considered an asset by the publisher 102. In part this is the case because the list allows the publisher, and any advertisers with whom the publisher contracts, to provide information to a group of people who are highly-focused in a particular area. This can be very desirable to an ad buyer, who can “piggy back” on the value of the publisher's list of document consumers, thereby leveraging the value of that list, in that the list assists both the publisher and also the ad buyer. Moreover, to the extent that mutually beneficial deals are struck between the document consumers and the ad buyers, the list is also leveraged in that the document consumers also benefit.

The printer 104 is typically a commercial business involved in the actual printing (i.e. the actual manufacture) of the documents 112. Thus, “the printer” 104 is typically not just an electro-mechanical device, but may be a document manufacturing company, having a number of aspects, as described below or easily envisioned. The printer 104 typically possesses, or controls and maintains the operation of, sophisticated printing machinery that can produce documents 112 of very high quality. Moreover, the printer may have facilities in a number of geographic areas, thereby assisting the printer in delivering documents to widely dispersed document consumers. For example, periodical “magazine” type documents may be produced. The printer 104 may maintain and control a sophisticated user interface 116 with which the printer communicates with a plurality of publishers 102(1) to 102(m) and possibly ad buyers 106(1) to 106(m). The user interface 116 may also be utilized to associate a plurality of groups of document consumers 108(1) to 108(m) associated with publishers 102(1) to 102(m), and a plurality of advertisement buyers (ad buyers 106(1) to 106(n). (Note: there is not necessarily a one-to-one association between publishers and ad buyers, since one ad buyer can buy ads from more than one publisher or more than one ad from a single publisher, and a single document can have more than one advertisement.) The user interface 116 can be configured in any desired manner, but is typically configured as a website, and is therefore created and supported by operation of the Internet and computing machinery and computer-executable instructions defined on computer-readable media.

As noted above, the printer may be a business entity with the capacity to manufacture a plurality of the printed documents 112. To more economically provide those documents in desired locations (e.g. close to the document consumers), the printer may have different printing facilities in different geographic areas, including facilities in different countries and facilities in different locations within any given country. In two examples, the printer may have both east coast and west coast facilities in the United States, or North American, Asian and European facilities. In a general example, the printer may have two or more facilities, and the two or more facilities may be located in different geographic areas. Thus, when a plurality of copies of the document is printed, a number of copies of the document may be printed in each of several locations. The locations wherein the copies of the document are printed can be selected for any reason, such as economy of scale, economy of transport and/or rapid delivery or other reason. Thus, if the document consumers are widely dispersed geographically, it may be less expensive and quicker for the documents 112 to be printed and/or manufactured in, and shipped from, two or more different geographic locations.

One or more ad buyer(s) 106(1) to 106(n) may optionally use the user interface 116. At least two versions of the system 100 are described. In a first example, the ad buyer 106 is known to the publisher 102. In this case, either the publisher 102 or the ad buyer 106 may utilize the user interface 116 and enter information as needed, concerning the ad buyer. Minimally, the advertisement from the ad buyer (typically in PDF form) is uploaded to the printer 104 and/or publisher 102 using the interface 116.

In a second example, one or more ad buyers 106 may visit the user interface 116 in hopes of finding a publisher 102 having a list 114 of document consumers 108 of interest to the ad buyer. In a typical example, the ad buyer 106 is looking for potential customers. Thus, if the ad buyer 106 is able to find a publisher 102 having a list 114 of document consumers 108 that appear to be potential customers for the ad buyer, then the ad buyer may be interested in paying the publisher to include the ad buyer's advertisements in the publisher's document 112.

In some circumstances, a plurality of ad buyers 106(1) through 106(n) are interested in placing their respective ads 118(1) through 118(n), respectively, in a particular publisher's document. This can be resolved, if the publisher allows some or all of the ad buyers 106(1) through 106(n) to place an ad in the publication. Alternatively, an auction can be held, wherein one or more ad buyers 106 willing to pay the publisher the most (or more, or over a threshold amount of) money will be allowed to place their advertisement. Thus, one or more “winning bids” in the auction can be allowed to place their ad in the publisher's document. In such an example, the user interface 116 may be used to conduct the auction.

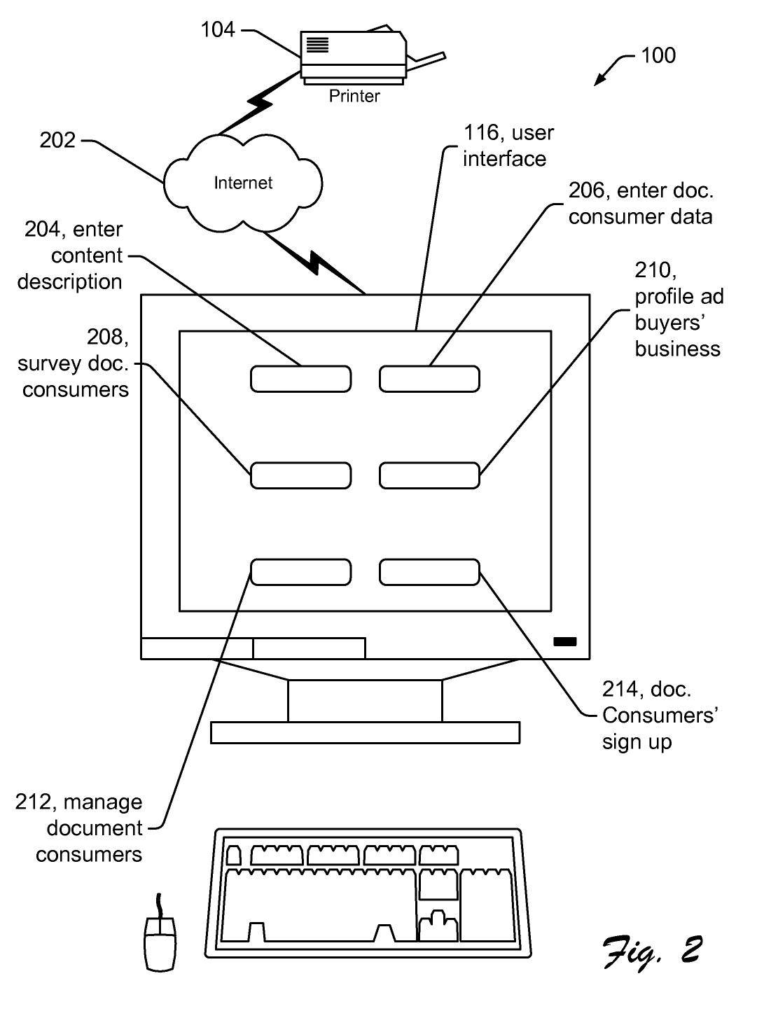

FIG. 2 illustrates an example of the user interface 116, shown in a diagrammatic form, intended for discussion of concepts involved in the document publishing system 100, and not intended to illustrate any required elements of appearance or function. Moreover, the user interface 116 can appear differently to different classifications of viewers. Thus, a content publisher 102 may see a different user interface than an ad buyer 106. Additionally, the user interface 116 may be owned and/or maintained by different parties. In a first example, the user interface 116 can be part of a website maintained by the printer 104 (recall that “the printer” is the corporation and/or individual that manufactures the documents 112). In alternative examples, the website may be operated by the publisher and/or the ad buyer(s). However, the discussion herein will assume that the user interface and website 116 is operated and maintained by the printer 104 and delivered to the viewer over the Internet 202.

The user interface 116 can include some or all of the elements discussed herein. The user interface 116 may provide a location 204 wherein the publisher 102 can enter data concerning the content to be published. This may be relevant in circumstances wherein ad buyers 106 frequent the website/interface 116 looking for publications distributed to potential customers. Thus, one or many ad buyer(s) and/or potential ad buyer(s) may be able to view, or review a summary of, the publisher's (or many publishers') content. For example, the content, or an abstract, summary, or key word digest of the content, may be entered into the user interface 116 and thereby made available to the ad buyers at location 204 within the user interface 116.

The user interface 116 may provide a location 206 wherein the publisher can enter data, typically in an abstract, individual and/or cumulative manner, concerning the characteristics of the document consumers 108 within the list 114 of document consumers. For example, location 206 may include expected expenditures (either individually or cumulatively) of the document consumers 108 on the list 114 in one or many areas and/or classifications of commerce. Thus in a first example, the user interface 116 may be configured to allow the list owner (typically the publisher) to enter information about the document consumers 108 into an area 206 of the user interface 116. This information—not actually identifying the document consumers to protect their anonymity and the value of the list—may be of interest to the ad buyers, in their decision to place an advertisement.

In a second example (either in alternative and/or in additional to the first example) the document consumers 108 may be surveyed by the user interface 116. Such a survey may allow each document consumer to enter expected expenditures in each of many areas (e.g. areas of commerce or product types). The characteristics (e.g. areas the document consumers are interested in making purchases) of the document consumers associated with one or more publishers can be identified. For example, the user interface 116 can include an area 208 wherein a survey is found that allows the document consumers to enter expected expenditures in different areas of commerce.

In a further example of the user interface 116, configured as a website for purposes of discussion, the interface may be adapted to allow the ad buyers (or the publishers or the printer) to enter a profile of the ad buyer(s)' business(es) into the user interface 116, such as at location 210. The profile typically indicates the type of products and/or services that are sold by the ad buyer. This information may be of interest to the publisher, to determine if the publisher is in direct business competition with the ad buyer.

Information contained within the user interface 116 can be used as input to a matching process, wherein the needs and/or profile of the content and needs of the publisher (e.g. as entered at location 204) the document consumers (e.g. as entered at locations 206 and 208), and the needs of the ad buyers (e.g. as entered at location 210), may be matched in such a way as to decide which ad buyer's ad should be included within the document 112. The matching process can be performed manually, but may be automated by use of a software implemented algorithm, key words and/or classifications of business activity and other tools as required.

The user interface 116 may also be configured to include a location 212 wherein the publisher can manage the list 114 of document consumers. Referring to FIG. 1, publishers 102(1) to 102(m) are each associated with a group of document consumers 108 (1) to (m) as defined by lists 114 (1) to (m). In one example, a publisher may grow (or contract) the list of document consumers 114 associated with that publisher's document by a “push” strategy. In a push strategy, the publisher can unilaterally add (or remove) a document consumer (i.e. a document recipient) to the list by entering (or removing) data concerning the new document consumer to the location 212. The push strategy is particularly adapted to circumstances wherein the publisher is sending the document to a group of people, and that group changes. For example, the publisher could be sending the document to a group of employees, members of a club, or clients with whom the publisher has done business within a set period of time. Thus, a new employee (or other person/entity) is “pushed” to the list 114 of the publisher 102, and thereby receives the document 112.

Additionally or alternatively, the publisher 102 can manage the list 114 of document consumers 108 using a “pull” strategy. In a “pull” strategy, the publisher can use two-way communication in an attempt to find potential document consumers. For example, the publisher may advertise or use other means in an attempt to get prospective document consumers to request a copy of the document 112 (or a subscription to the document). Thus, the new or prospective document consumers “pull” the document to them. The new consumers may sign themselves up for a copy of the document (or a subscription) at location 214 of the user interface 116. Alternatively, the publisher may enter data in the user interface 116, such as at location 212, thereby maintaining the list 114.

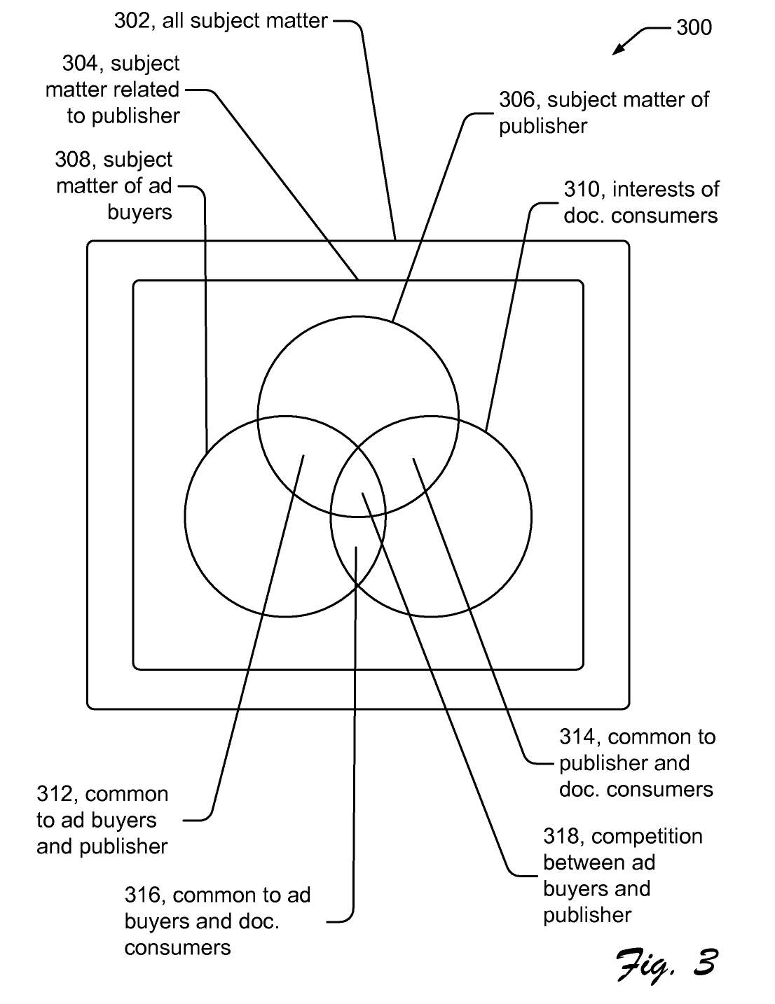

FIG. 3 illustrates an example, expressed as a diagram 300, of the relative interests of the publisher 102 (content author), the ad buyers 106 (advertisers) and the document consumers 108 (document receivers and associates). The diagram shows a region of all subject matter 302, which may be regarded as all commercial, educational, governmental, recreational, and other areas of interest, information or general data.

Within this region is a region 304 that is “related” to the subject matter of the publisher's content. Thus, if the publisher is a real estate agent and the publisher's content is related real estate sales, then real estate financing, home builders, plumbers, electricians and others would be within the “related” region 304. Other topics, such as rocket science, would be within region 302, but not within region 304.

The area 306 represents the area of subject matter of the content 110 of the publisher 102. The content typically includes one or more related articles. For example, if the content is produced by a real estate agent, then the content may include subject matter related to what to look for in a new house, tips for selling a current house, and the like.

The area 308 represents the area of subject matter of one or more ad buyers 106. This area may be cumulative or collective, in that it may reflect more than one ad buyer. For example, the ad buyers of interest to the real estate agent may include a bank, a home builder, an interior decorator or a home repair contractor.

The area 310 represents the area of interest to (usually a number of) document consumers 108. Collectively, the document consumers may have a number of interests, and an appropriate region 310 is defined within a portion of the area 304.

The area 312 is the intersection between regions 306 and 308. Thus, that area represents the areas of common interests between the content 110 of the publisher 102 and the ad buyers 106. In general, the publisher 102 will try to avoid publishing ads from ad buyers within 312, since they may be direct business competitors. In contrast, ad buyers whose business activities are within 308, but not in 312, may be more compatible to the publisher.

The region 314 represents the intersection between regions 306 and 310, and includes the overlap in the subject matter of the document 112 and the interests of the document consumers. Thus, region 314 represents the region of shared interest between the publisher and the publisher's content and the needs and interests of the document consumers.

The region 316 represents the intersection between regions 308 and 310, and includes overlap in subject matter of the ad buyers and document consumers. The area 316, minus the area 318 (which includes aspects of competition between the publisher and ad buyers) represents the area that the publisher should emphasize to ad buyers, since document consumers in this area are in need of the ad buyers' services.

### EXAMPLE METHODS

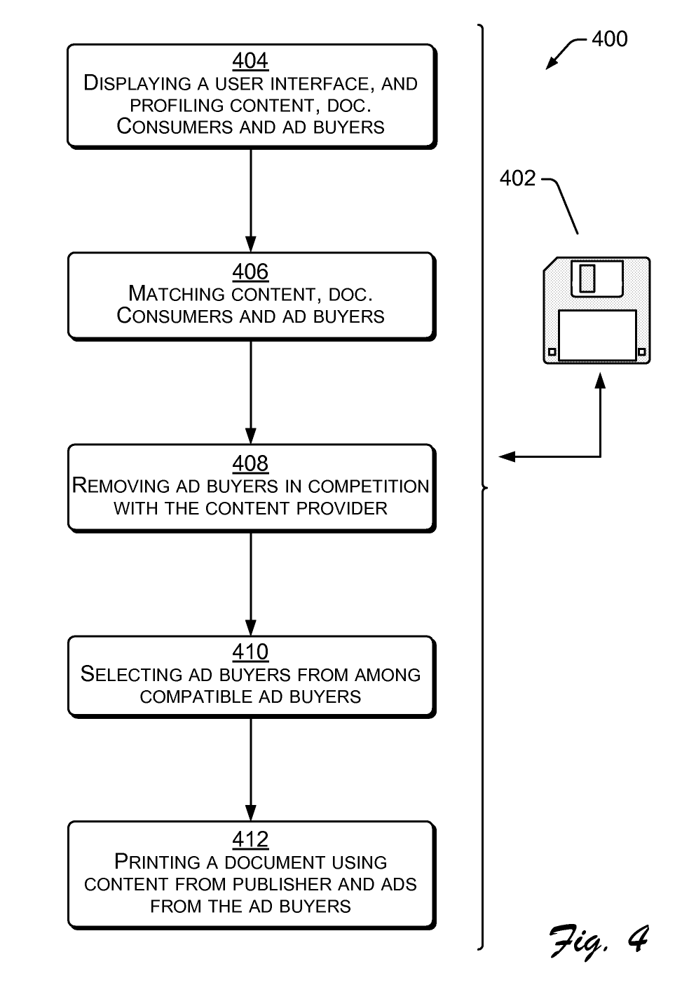

Referring to FIG. 4, an example of a document publishing process 400 is discussed. This example is meant to be representative of other such methods. For purposes of discussion, the method 400 will be illustration at various points by reference to the system 100 of FIG. 1, the user interface 116 of FIG. 2 and the diagram 300 of FIG. 3. The elements of the described methods may be performed by any appropriate means including, for example, hardware logic blocks on an ASIC or by the execution of processor-readable instructions defined on a processor-readable medium, seen for purposes of illustration only, as disk 402.

At block 404, a user interface is displayed, allowing data to be entered. In one example, data concerning a profile of content 110 of a document 112 created (e.g. authored) by a publisher 102 can be entered. In the example of FIG. 2, this data could be entered into location 204 of user interface 116. Also, data concerning a profile of the document consumers can be entered. In the example of FIG. 2, this data could be entered into location 206 of user interface 116. For example, the area of business, education, background and/or any other relevant data could be entered. Also, a survey (e.g. including information given by the document consumers) of the needs and predicted expenditures of the document consumers in various areas of goods and services can be entered into the user interface 116. In the example of FIG. 2, this data could be entered into location 208. And further, data concerning a profile of the ad buyers can be entered. In the example of FIG. 2, this data could be entered into location 210 of user interface 116. For example, the area of business, products, services or classifications of products/services, background and/or any other relevant data could be entered into location 210.

Blocks 406-410 may be performed “manually,” such as, for example, by the publisher or other party reviewing data input to the user interface. Alternatively, these blocks may be performed in an automated manner, such as by operation of an algorithm within a software application.

At block 406, the content and document consumers are matched to prospective ad buyers. This results in an initial selection or collection of ad buyers having goods and/or services that are “complementary” to, or that “match,” the content provided by the publisher. The matching may be performed by software, e.g. a “matching engine,” or by a manual process. Where the software matching engine is utilized, input may be received from the user interface. Referring to FIG. 3, a desirable match is in the region 316. The region 316 includes subject matter that is related to the content 306 (because it is inside box 304) but outside the turf of the publisher (i.e. outside region 306) and yet inside the regions of interest 306, 310 of the ad buyers and document consumers, respectively. For example, the profile of the content (e.g. entered to region 204 of the user interface 116) and the profile of the document consumers (e.g. entered into region 206) can be used to find ad buyers that would be interested in placing an ad into a document, together with the publisher's content, for publication as a document. In one example of this matching, one or more ad buyers may have entered their profile as data into the user interface 116 at location 210. This allows the publisher to select an ad buyer in a manual manner by reviewing the input from one or more potential ad buyers. In a second example, where two or more of the publisher, document consumers and/or the potential ad buyers have entered key words or classified their input, a software matching algorithm may be used to match the content of the publisher's document with one or more appropriate ad buyers in an automated manner.

The document consumers 108 on the list 114 of any publisher 102 may not all be located in the same geographic area (e.g. same country, state or metropolitan area). In fact, the document consumers 108 on any list 114 may be widely dispersed. Because of regional differences, the matching process at block 406 may match one ad buyer with document consumers on the list 114 in a first geographical area or region, and match another ad buyer(s) (or the same ad buyer but a different advertisement(s)) with document consumers in a second (third, and/or additional) geographical area(s) or regions. For example, documents prepared for consumption by document consumers in the north may be matched with ad buyers having advertisements promoting winter merchandise, while document buyers in the south may be matched with ad buyers having alternative advertisements. Thus, according to one example of the matching process of block 406, the documents 112 sent to document consumers 108 associated with any list 114 may have different advertisements due to matching with different ad buyers, and the differences could be related to the geographic location of the document consumers.

At block 408, ad buyers who are appear (either to the publisher and/or an automated software algorithm) to be in business competition with the publisher are removed from consideration, thereby resulting in “compatible” ad buyers. The removal can be performed manually, such as by allowing the publisher to view the user interface, identify ad buyers that are in business competition with the publisher, and remove them from consideration. Alternatively, the removal can be performed by operation of a software algorithm. Such an algorithm may examine key words or classifications profiling the publisher's document and key words or classifications in the ad buyer's profile, and remove the ad buyers who appear to be in business competition with the publisher.

At block 410, ad buyers are selected from among the compatible ad buyers, i.e. an ad buyer is selected from among those ad buyers that are both complementary (e.g. in the same general business area) and compatible (e.g. not in direct competition). The selection process may be performed in several manners. In one example, the publisher simply makes arrangement with one or more ad buyers, thereby selecting advertisements from those ad buyer(s) for the published document. In a second example, ad buyers are provided with results of a survey projecting expenditure amounts of the document consumers associated with a plurality of different publishers. The ad buyers are then allowed to bid to buy ads from the plurality of different publishers. In one example, the bids are entered into the user interface 116. The publisher is able to select a preferred bid.

In a further example of the operation of block 410, a plurality of ad buyers may buy ads from a plurality of publishers. For example, a plurality of ad buyers may be provided with results of a survey projecting expenditure amounts of the document consumers associated with areas complementary, adjacent or related to a plurality of different publishers. Using this information, each of the plurality of ad buyers may be allowed to bid to buy ads from one or more of the plurality of different publishers.

Accordingly, the user interface 116 of the printer 104 could be configured as a meeting and associating place, wherein content-generating publishers could be paired with one or more complementary ad buyers, and wherein ad buyers could place ads in the complementary documents associated with one or more publishers.

At block 412, a document 112 is printed by the printer 104, using content from the publisher and ads from the ad buyers.

While one or more methods have been disclosed by means of flow diagrams and text associated with the blocks of the flow diagrams, it is to be understood that the blocks do not necessarily have to be performed in the order in which they were presented, and that an alternative order may result in similar advantages. Furthermore, the methods are not exclusive and can be performed alone or in combination with one another.

### CONCLUSION

Although aspects of this disclosure include language specifically describing structural and/or methodological features of preferred embodiments, it is to be understood that the appended claims are not limited to the specific features or acts described. Rather, the specific features and acts are disclosed only as exemplary implementations, and are representative of more general concepts.

1. A method of publishing a document, comprising:
providing a user interface configured for creating a profile of: content from a publisher of the document; a plurality of document consumers; and a plurality of ad buyers;
removing from the plurality of ad buyers those ad buyers whose goods or services are found to overlap areas of goods or services offered by the publisher, wherein the removing is performed in an automated manner where the profile indicates overlap, and as a backup, in a manual manner by a user operating the user interface;
matching the document consumers with the plurality of ad buyers according to the profile to find ad buyers that are compatible with the document; and
combining the content provided by the publisher, together with ads provided by ad buyers found to be compatible with the document, to produce the document.

2. The method of claim 1, wherein the matching comprises:
auctioning, to ad buyers, a right to include an ad within the document; and
selecting at least two ad buyers based in part on relative amounts of bids within the auction;
wherein a first of the at least two ad buyers selected places an advertisement within the document sent to document consumers in a first region but not in a second region, and a second of the at least two ad buyers selected places an advertisement within the document sent to document consumers in the second region but not in the first region.

3. The method of claim 1, wherein the matching comprises:
providing the ad buyers with results of a survey projecting expenditure amounts of the document consumers associated with a plurality of different publishers; and
allowing a plurality of ad buyers to bid, based on the survey, to buy ads from the plurality of different publishers.

4. A method of publishing a document, comprising:
providing a user interface, wherein regions are defined within the user interface into which information may be entered as input for activities, the activities comprising:
profiling subject matter of content provided by a publisher;
profiling subject matter of needs, related to the subject matter of content provided by the publisher, of a plurality of document consumers;
profiling subject matter of needs, related to the subject matter of content provided by the publisher, of a plurality of ad buyers;
matching the subject matter of the needs of the plurality of document consumers with the subject matter of needs of the plurality of ad buyers to find ad buyers that are compatible with the document;
selecting ad buyers from among those found to be compatible with the document; and
combining the content provided by the publisher together with ads provided by selected ad buyers to produce the document.

5. The method of claim 4, wherein:
profiling subject matter of content provided by a publisher comprises defining subject matter of the content using key words;
profiling subject matter of needs of a plurality of document consumers comprises defining subject matter of interests of the document consumers, using key words, that is related to content provided by the publisher;
profiling subject matter of needs of a plurality of ad buyers comprises defining products and services related to content provided by the publisher using key words; and
printing content comprises printing a plurality of copies of the document, wherein some of the copies are printed in a first geographic location and others of the copies are printed in a second geographic location.

6. The method of claim 4, wherein matching the subject matter of the needs of the plurality of document consumers with the subject matter of needs of the plurality of ad buyers to find ad buyers that are compatible with the document comprises removing ad buyers from consideration based on a process by which a survey projecting expenditure amounts of the document consumers in areas is compared to products for sale by the ad buyers in the areas.

7. The method of claim 4, wherein selecting ad buyers compatible with the document consumers comprises selecting only ad buyers in areas that are different from, but complimentary to, the publisher.

8. The method of claim 4, wherein selecting ad buyers from among those found to be compatible with the document consumers comprises:
auctioning, to ad buyers, a right to include an ad within the document; and
selecting at least one ad buyer based on relative amounts of bids within the auction by the ad buyers.

9. The method of claim 4, additionally comprising:
expanding a list of document consumers managed by the publisher by operation of a pull strategy, wherein two-way communication with new subscribers adds new subscribers to the list of document subscribers.

10. The method of claim 4, additionally comprising:
expanding a list of document consumers managed by the publisher by operation of a push strategy, wherein the publisher unilaterally adds document consumers to the list of document consumers.

11. A system for printing a document, comprising:
a user interface configured for use in publishing the document, the user interface comprising regions into which the user may enter information as input for activities, the activities comprising:
profiling subject matter of content provided by a publisher;
profiling subject matter of needs, related to the subject matter of content provided by the publisher, of a plurality of document consumers;
profiling subject matter of needs, related to the subject matter of content provided by the publisher, of a plurality of ad buyers;
a matching engine, configured to:
match key words associated with the subject matter of the needs of the plurality of document consumers with key words associated with the subject matter of needs of the plurality of ad buyers to find ad buyers that are compatible with the document; and
select ad buyers from among those found to be compatible with the document based in part on value offered and in part on user input to the user interface; and
a printer, configured to print the content provided by the publisher together with ads provided by selected ad buyers to produce the document.

12. The system of claim 11, wherein the matching engine receives input from a location defined by the user interface into which a user may enter ad buyers.

13. The system of claim 11, wherein the matching engine directs the user interface to:
provide the ad buyers with results of a survey projecting expenditure amounts of the document consumers associated with a plurality of different publishers, wherein characteristics of the document consumers associated with each publisher are identified; and
allow a plurality of ad buyers to bid to buy ads from the plurality of different publishers.

14. The system of claim 11, wherein the matching engine, when matching the subject matter of the needs of the plurality of document consumers with the subject matter of needs of the plurality of ad buyers to find ad buyers that are compatible with the document, removes ad buyers from consideration based on a process by which a survey projecting expenditure amounts of the document consumers in areas is compared to products for sale by the ad buyers in the areas.

15. The system of claim 11, wherein the user interface allows the publisher to remove ad buyers compatible with the document consumers if goods or services of the ad buyers overlap those of the publisher.
